(19) United States
(12) Patent Application Publication
(10) Pub. No.: US 2018/0336786 A1
(43) Pub. Date: Nov. 22, 2018

(54) COLLISION AVOIDANCE METHOD AND SYSTEM

(71) Applicant: Ford Global Technologies, LLC, Dearborn, MI (US)

(72) Inventors: Stuart C. Salter, White Lake, MI (US); Paul Kenneth Dellock, Northville, MI (US); Stephen Kenneth Helwig, Farmington Hills, MI (US); Aaron Bradley Johnson, Allen Park, MI (US)

(73) Assignee: Ford Global Technologies, LLC

(21) Appl. No.: 15/600,312

(22) Filed: May 19, 2017

(51) Int. Cl. G08G 1/16; B60Q 9/00; B60Q 1/32; B60Q 1/26; E05B 81/76

(52) U.S. Cl. CPC G08G 1/166; B60Q 9/008; E05B 81/76; B60Q 1/2661; B60Q 1/323

(57) ABSTRACT

A method and system for avoiding collisions in a motor vehicle is provided. Specifically, a motor vehicle includes one or more proximity sensors on an interior door of the motor vehicle that are configured to determine that an operator is going to open a car door. The motor vehicle also includes a collision detection assembly configured to detect if another motor vehicle or obstacle is approaching. If the other motor vehicle or obstacle is approaching the motor vehicle at about the same time the operator is moving to open a door, the motor vehicle may actuate one or more warning signals, including but not limited to, exterior lights and an interior warning chime, and may also prohibit unlatch of the car door for a period of time.

### FIELD OF THE INVENTION

The present disclosure generally relates to methods and systems for collision avoidance in motor vehicles.

### BACKGROUND OF THE INVENTION

The action of opening a motor vehicle door can cause a collision with another motor vehicle or other obstacle that is just outside the motor vehicle door. Often the motor vehicle or other moving obstacle (e.g., a bike or pedestrian) is not seen as a collision threat because the moving obstacle is not visible to the operator when he/she is moving to open the door. However, by the time the decision has been made to open the door, and the door is opened, the moving obstacle has moved into a position to be a collision threat with the motor vehicle.

### SUMMARY OF THE INVENTION

According to one aspect of the present invention, a method for actuating a warning light on a motor vehicle is provided. The method includes detecting a operator's hand in close proximity to an interior handle of a door having at least one proximity sensor on the interior handle. The method also includes receiving position data for a moving obstacle relative to the motor vehicle, and determining that the moving obstacle is a collision threat to the opening of the door based on the position data. If the moving obstacle is determined to be a collision threat, the method includes actuating the warning light.

According to another aspect of the present invention, a method for avoiding a collision in a motor vehicle is provided. The method includes detecting an operator's hand in close proximity to an interior handle of a door having at least one proximity sensor on the interior handle. The method also includes detecting, by a collision avoidance system coupled to the motor vehicle, a moving obstacle outside of the motor vehicle, and determining that the moving obstacle is a collision threat to the opening of the door. If the moving obstacle is determined to be a collision threat, the method includes actuating a warning signal.

Embodiments of the aspect of the invention can include any one or a combination of the following features:
determining that the moving obstacle is a collision threat to the opening of the door based on a the moving obstacle's distance from the motor vehicle;
determining that the moving obstacle is a collision threat to the opening of the door based on a calculation of the moving obstacle reaching the motor vehicle in under a threshold time period based on a traveling speed of the moving obstacle and the moving obstacle's distance from the motor vehicle;
the warning signal comprises a warning light on an exterior surface of the motor vehicle;
the warning light comprises a luminescent structure;
the warning light comprises a plurality of LEDs;
the warning signal comprises a warning sound within the motor vehicle;
the method includes delaying a door latch to unlatch the door;

According to yet another aspect of the present invention, a system for avoiding collisions in a motor vehicle is provided. The system includes at least one proximity sensor on an interior door handle for detecting an operator's hand in close proximity to the interior door handle. The system also includes a collision avoidance system for detecting a moving obstacle outside of the motor vehicle, as well as the moving obstacle's distance from the motor vehicle. The system further includes a warning light on an exterior surface of the motor vehicle, and control circuitry coupled to the at least one proximity sensor, the collision avoidance system and the warning light. The control circuitry is configured to actuate the warning light based on detection of the operator's hand in close proximity to the interior door handle and the moving obstacle being within a threshold distance from the motor vehicle

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a luminescent structure rendered as a coating, according to various embodiments;

FIG. 1B is a top view of a luminescent structure rendered as a discrete particle according to various embodiments;

FIG. 1C is a side view of a plurality of luminescent structures rendered as discrete particles and incorporated into a separate structure;

FIG. 2 is a side perspective view of a motor vehicle according to an embodiment described herein;

FIG. 3 is an enlarged side perspective view of a portion of a lighting assembly according to an embodiment described herein;

FIG. 4 is a partial view of an interior portion of the motor vehicle according to an embodiment disclosed herein;

FIG. 5 is a top, side perspective view of an interior door handle of a motor vehicle according to an embodiment disclosed herein;

FIGS. 6 and 7 are side perspective views of an operator's hand moving toward, and grabbing, respectively, an interior door handle of the motor vehicle according to an embodiment disclosed herein;

FIG. 8 is a top view of a potential collision scenario according to an embodiment disclosed herein;

FIG. 9 is a top view of another potential collision scenario according to an embodiment disclosed herein;

FIG. 10 is a block diagram of control circuitry of a motor vehicle according to an embodiment disclosed herein;

FIG. 11 is a flow chart describing a collision avoidance process according to an embodiment disclosed herein; and

FIG. 12 is another flow chart of a collision avoidance method according to another embodiment disclosed herein.

### DETAILED DESCRIPTION OF THE PREFERRED EMBODIMENTS

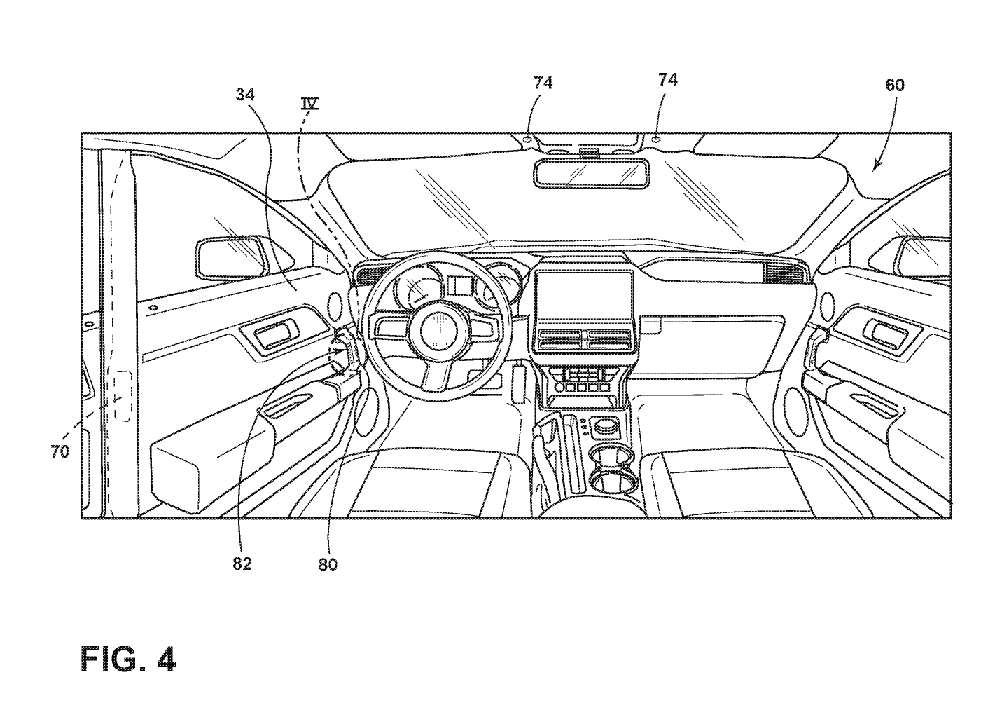

For purposes of description herein, the terms “upper,” “lower,” “right,” “left,” “rear,” “front,” “vertical,” “horizontal,” and derivatives thereof shall relate to the invention as oriented in FIG. 4. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed embodiments of the present invention are disclosed herein. However, it is to be understood that the disclosed embodiments are merely exemplary of the invention that may be embodied in various and alternative forms. The figures are not necessarily a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

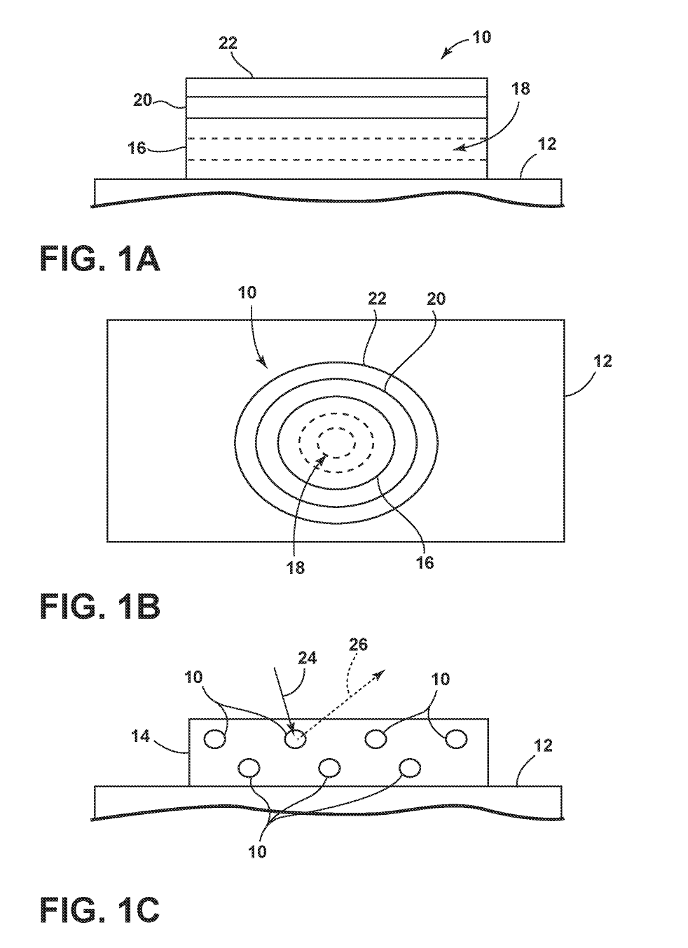

FIGS. 1A-1C describe a light assembly for a vehicle. In various embodiments, the light assembly utilizes light generated by a conventional light source to excite one or more phosphorescent and/or luminescent structures. The one or more luminescent structures may be configured to convert excitation light received from the associated light source and re-emit the light at a different wavelength typically found in the visible spectrum.

Referring to FIGS. 1A-1C, various exemplary embodiments of luminescent structures 10 are shown, each capable of being coupled to a substrate 12, which may correspond to a vehicle fixture or vehicle-related piece of equipment. In FIG. 1A, the luminescent structure 10 is generally shown rendered as a coating (e.g., a film) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film) that may then be applied (as shown) or integrated with the substrate 12.

At the most basic level, a given luminescent structure 10 includes an energy conversion layer 16 that may include one or more sublayers, which are exemplarily shown through broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an excitation light 24 of a specific wavelength, thereby causing the light to undergo a conversion process. Under the principle of down conversion, the excitation light 24 is converted into a longer wavelength, converted light 26 that is outputted from the luminescent structure 10. Conversely, under the principle of up conversion, the excitation light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

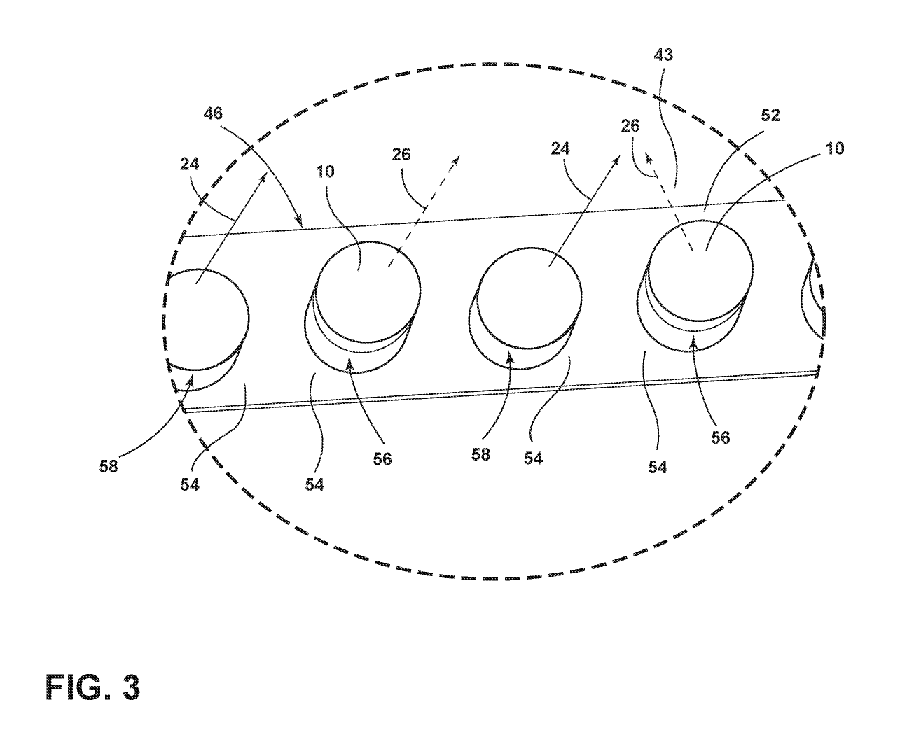

Light emitted by a light source 54 (FIG. 3) may be referred to herein as excitation light 24 and is illustrated herein as solid arrows. In contrast, light emitted from the luminescent structure 10 may be referred to herein as converted light 26 and may be illustrated herein as broken arrows to represent the luminescence.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In various embodiments, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principal driving mechanism for an energy conversion process corresponding to a change in wavelength of light. In the various embodiments discussed herein, each of the luminescent structures 10 may operate under either conversion principle.

Referring back to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

Additional information regarding the construction of luminescent structures 10 is disclosed in U.S. Pat. No. 8,232,533 to Kingsley et al., the entire disclosure of which is incorporated herein by reference. For additional information regarding fabrication and utilization of luminescent materials to achieve various light emissions, refer to U.S. Pat. No. 8,207,511 to Bortz et al., U.S. Pat. No. 8,247,761 to Agrawal et al., U.S. Pat. No. 8,519,359 to Kingsley et al., U.S. Pat. No. 8,664,624 to Kingsley et al., U.S. Patent Publication No. 2012/0183677 to Agrawal et al., U.S. Pat. No. 9,057,021 to Kingsley et al., and U.S. Pat. No. 8,846,184 to Agrawal et al., all of which are incorporated herein by reference in its entirety.

According to various embodiments, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG:Ce and may be a short-persistence luminescent material 18. For example, an emission by Ce³⁺ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

According to various embodiments, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in various embodiments, the rare earth aluminum garnet type Ce phosphor may serve as the luminescent material 18 with ultra-short-persistence characteristics, which can emit the converted light 26 by absorbing purple to blue excitation light 24 emitted from the light source 54. According to various embodiments, a ZnS:Ag phosphor may be used to create a blue converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material known in the art may be utilized without departing from the teachings provided herein. Additional information regarding the production of short-persistence luminescent materials is disclosed in U.S. Pat. No. 8,163,201 to Agrawal et al., the entire disclosure of which is incorporated herein by reference.

Additionally, or alternatively, the luminescent material 18, according to various embodiments, disposed within the luminescent structure 10 may include a long-persistence luminescent material 18 that emits the converted light 26, once charged by the excitation light 24. The excitation light 24 may be emitted from any excitation source (e.g., any natural light source, such as the sun, and/or any artificial light source 54). The long-persistence luminescent material 18 may be defined as having a long decay time due to its ability to store the excitation light 24 and release the converted light 26 gradually, for a period of several minutes or hours, once the excitation light 24 is no longer present.

The long-persistence luminescent material 18, according to various embodiments, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in various embodiments, for a period substantially longer than 60 minutes (e.g., the period may extend 24 hours or longer, and in some instances, the period may extend 48 hours). Accordingly, the long-persistence luminescent material 18 may continually illuminate in response to excitation from any light source 54 that emit the excitation light 24, including, but not limited to, natural light source (e.g., the sun) and/or any artificial light source 54. The periodic absorption of the excitation light 24 from any excitation source may provide for a substantially sustained charge of the long-persistence luminescent material 18 to provide for consistent passive illumination. In various embodiments, a light sensor (not shown) may monitor the illumination intensity of the luminescent structure 10 and actuate an excitation source when the illumination intensity falls below 0.32 mcd/m², or any other predefined intensity level.

The long-persistence luminescent material 18 may correspond to alkaline earth aluminates and silicates, for example, doped di-silicates, or any other compound that is capable of emitting light for a period of time once the excitation light 24 is no longer present. The long-persistence luminescent material 18 may be doped with one or more ions, which may correspond to rare earth elements, for example, Eu2+, Tb3+, and/or Dy3. According to one non-limiting exemplary embodiment, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to various embodiments, may be a translucent white color, and in some instances reflective, when unilluminated. Once the luminescent structure 10 receives the excitation light 24 of a particular wavelength, the luminescent structure 10 may emit any color light (e.g., blue or red) therefrom at any desired brightness. According to various embodiments, a blue emitting phosphorescent material may have the structure Li₂ZnGeO₄ and may be prepared by a high-temperature solid-state reaction method or through any other practicable method and/or process. The afterglow may last for a duration of 2-8 hours and may originate from the excitation light 24 and d-d transitions of Mn2+ ions.

According to an alternate non-limiting exemplary embodiment, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

Additional information regarding the production of long-persistence luminescent materials is disclosed in U.S. Pat. No. 8,163,201 to Agrawal et al., the entire disclosure of which is incorporated herein by reference. For additional information regarding long-persistence phosphorescent structures, refer to U.S. Pat. No. 6,953,536 to Yen et al., U.S. Pat. No. 6,117,362 to Yen et al., and U.S. Pat. No. 8,952,341 to Kingsley et al., all of which are incorporated herein by reference in their entirety.

With further reference to FIGS. 1A-1C, according to various embodiments, the luminescent material 18 may include one or more quantum dots. Quantum dots are nanoscale semiconductor devices that tightly confine either electrons or electron holes in three spatial dimensions and may be luminescent. The luminescence of a quantum dot can be manipulated to specific wavelengths by controlling the particle diameter of the quantum dots. Quantum dots may have a radius, or a distance half of their longest length, in the range of between about 1 nm and about 10 nm, or between about 2 nm and about 6 nm. Larger quantum dots (e.g., radius of 5-6 nm) emit longer wavelength light resulting in the color of the light being such colors as orange or red. Smaller quantum dots (e.g., radius of 2-3 nm) emit shorter wavelengths resulting in colors such as blue and green. It will be understood that the wavelength of light emitted from the quantum dots may vary depending on the composition of the quantum dots. Quantum dots naturally produce monochromatic light. Exemplary compositions of the quantum dots include LaF₃ quantum dot nanocrystals that are doped (e.g., coated) with Yb—Er, Yb—Ho and/or Yb—Tm. Other types of quantum dots that can be used include various types of tetrapod quantum dots and perovskite-enhanced quantum dots. It will be understood that one or more types of quantum dots may be mixed or otherwise used in the luminescent material 18 to achieve a desired color or hue to the converted light 26.

The quantum dot embodiments of the luminescent material 18 may be configured to emit light in response to the excitation light 24. According to various embodiments, the quantum dots may be configured to emit light by up-converting excitation light 24. In up-conversion processes, two or more photons of a longer wavelength excitation light 24 are absorbed. Once absorbed, the quantum dots may emit one or more photons having a shorter wavelength than the wavelengths of the excitation light 24. According to various embodiments, the excitation light 24 may be in the infrared (IR) light spectrum. In such embodiments, the excitation light 24 may have a wavelength of between about 800 nm and about 1000 nm. In one exemplary embodiment, the excitation light 24 may have a wavelength of between 900 and 1000 nm, such as 980 nm. A wavelength between 900 and 1000 nm is chosen since red, blue and green emitting colloidal quantum dots of these species can efficiently absorb this wavelength of excitation light 24. This wavelength of light may be readily emitted from heated vehicle components, e.g., a light source 54 (FIG. 3). This means the luminescent structure 10 can emit virtually any color of converted light 26, including, but not limited to, converted light 26 within the white spectrum, when charged or excited with IR excitation light 24 and the proper sized quantum dots are used.

According to aspects of the present disclosure, a luminescent structure 10, as described above, as well as other light sources, may be incorporated as part of an exterior surface of a motor vehicle 30, and selectively actuated to warn an approaching motor vehicle or other moving obstacle, to prevent a collision with motor vehicle 30. More particularly, as described in more detail below, a vehicle control system 120 of motor vehicle 30 may be configured to receive information from various vehicle systems, and to actuate one or more warning signals, including but not limited to exterior and/or interior warning lights, warning sounds, as well as a delay or prohibit a door unlatch feature. According to at least some embodiments, to activate the warning signals, motor vehicle 30 may process information received from, but not limited to: one or more proximity sensors that sense when an operator is about to open or is trying to open a door of the motor vehicle; and a back-up camera, an ultrasonic collision avoidance system, a collision radar, or other collision detection assembly. These and other embodiments are discussed in more detail below.

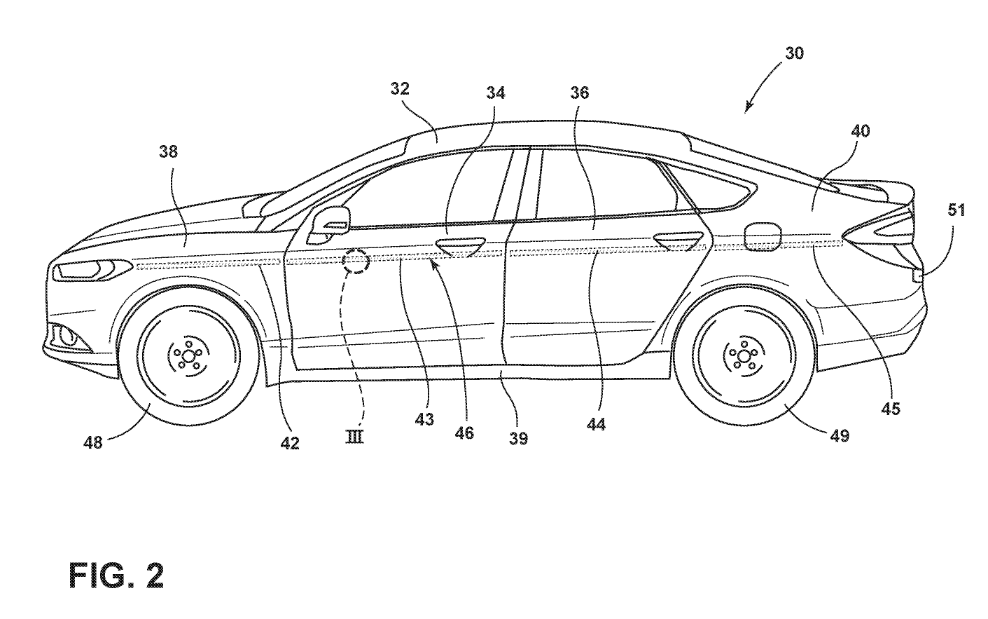

Referring to FIG. 2, in at least one embodiment, a motor vehicle 30 is illustrated, in general, as including a vehicle body 32 having a front body portion 38, a middle body portion 39 and a rear body portion 40. In between front body portion 38 and rear body portion 40, motor vehicle 30 includes a pair of front doors 34 (only one shown), a pair of rear doors 36 (only one shown), a front wheel assembly 48 (one of a pair, pair not shown) and a rear wheel assembly 49 (one of a pair, pair not shown).

According to the illustrated embodiment, motor vehicle 30 may also include one or more assemblies that may be selectively controlled by a vehicle control system 120, discussed in more detail below. For example, motor vehicle 30 may include one or more backup aids or collision detection systems, such as collision detection assembly 51, which may be incorporated on the rear body portion, for detecting vehicles or other moving obstacles behind motor vehicle 30. Motor vehicle 30 may also include a lighting assembly 46 incorporated on an exterior surface of vehicle body 32 that may be selectively controlled by a vehicle control system 120. In some cases, lighting assembly 46 may include multiple portions. Specifically, according to at least one embodiment disclosed herein motor vehicle 30 includes a lighting assembly front portion 42, a lighting assembly front door portion 43, a lighting assembly rear door portion 44, and a lighting assembly rear portion 45, collectively, lighting assembly 46. As described in more detail below, lighting assembly portions 42, 43, 44, and 45 may be independently controlled together as a group by vehicle control system 120.

Although only one side of motor vehicle 30 is shown in FIG. 2, portions of the opposite side (body, doors, wheel assembly, etc.) may be substantially the same as shown in FIG. 2, and can also incorporate a lighting assembly 46, as described herein. However, in various and other embodiments, the lighting assembly 46 may be incorporated only in one side of the motor vehicle 30 (e.g. driver side), and/or may be incorporated in other portions and locations of the vehicle body 32. Further in the illustrated embodiment of FIG. 2, motor vehicle 30 is configured as a four-door sedan vehicle. Additionally, it will be understood that aspects of the present disclosure may be incorporated in other types of motor vehicles, including but not limited to other types of cars, trucks, commercial vehicles, and any other type and style of motor vehicle contemplated by a skilled artisan.

Collision detection assembly 51 may be configured with a variety of functionalities as would be known and adapted by a skilled artisan. According to aspects of the embodiments described herein, collision detection assembly 51 may be configured to sense or otherwise recognize one or more moving obstacles (e.g., other vehicles, bikes, pedestrians, etc.) outside of motor vehicle 30. Collision detection assembly 51 may also identify or measure parameters related to the moving obstacle, such as type of moving obstacle, speed of moving obstacle, distance and direction from motor vehicle 30, direction of travel, as well as other parameters contemplated by a skilled artisan and relevant to the particular type of collision detection system. Collision detection assembly 51 may be coupled with vehicle control system 120 and configured to communicate information, such as the parameters related to the moving obstacle, to vehicle control system 120.

Collision detection assembly 51 may be embodied according to collision detection systems and techniques that would be known and adapted by a skilled artisan. For example, collision detection assembly 51 may include infrared sensors, video image sensors, ultrasonic sensors, radar sensors, a hybrid of any of these technologies or any other similar technology as would be known or contemplated in the art. Furthermore, while collision detection assembly 51 is disposed on a rear body portion 40 in FIG. 2, it shall be understood that the placement is only illustrative and may be embodied in other locations of motor vehicle 30.

Lighting assembly 46 may be configured to selectively emit light along an exterior portion of motor vehicle 30. In some cases, lighting assembly 46 may be configured as a conventional exterior light panel having a plurality of conventional light sources (e.g., light emitting diodes (LEDs)) grouped together and encased by a transparent light carrying medium. In other cases, lighting assembly 46 may include a plurality of luminescent structures, as described above. In at least one embodiment, lighting assembly 46 includes a combination of conventional light sources 54, wherein a portion of the light sources 54 incorporate a luminescent structure 10, as shown in the enlarged section of lighting assembly front door portion 43 in FIG. 3.

According to the illustrated embodiment shown in FIG. 3, lighting assembly 46 may include one or more light sources 54 disposed on a substrate 52, such as a printed circuit board (PCB). The substrate 52 may contain control circuitry including light source drive circuitry for controlling activation and deactivation of one or more light sources 54 that may be deposited or printed on the substrate 52. The substrate 52 may be any type of circuit board including, but not limited to, any flexible and/or rigid circuit board. Lighting assembly 46, via control circuitry, may also be coupled with vehicle control system 120 for driving lighting assembly 46.

With respect to the embodiments described herein, the light sources 54 may each be configured to emit visible and/or non-visible light, such as blue light, UV light, infrared, and/or violet light and may include any form of light source. For example, fluorescent lighting, LEDs, organic LEDs (OLEDs), polymer LEDs (PLEDs), laser diodes, quantum dot LEDs (QD-LEDs), solid-state lighting, a hybrid of these or any other similar device, and/or any other form of lighting may be utilized within the lighting assembly 46.

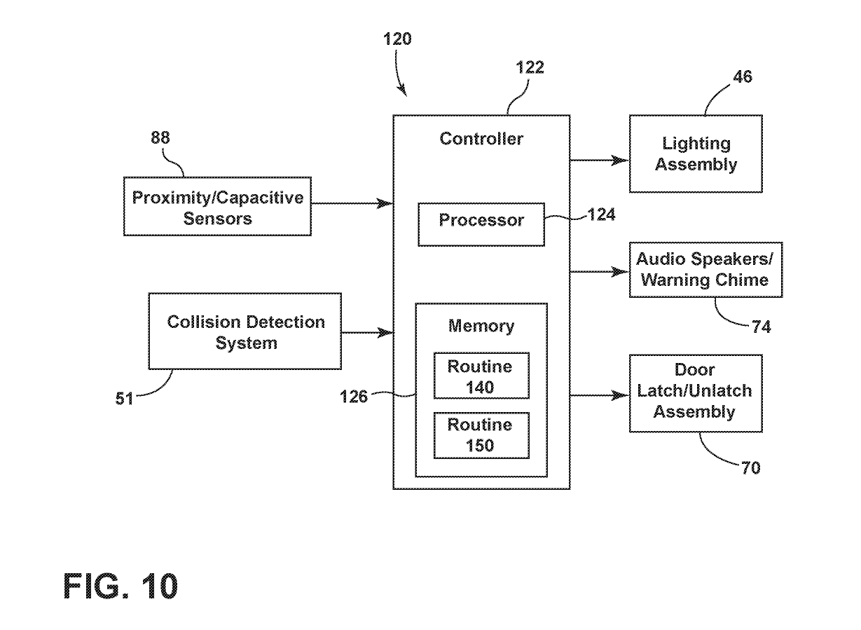

According to some embodiments, the luminescent structure 10 may be disposed on a first portion 56, or all, of the light sources 54. A second portion 58 of the light sources 54 may be free of a luminescent material. According to various embodiments, the light sources 54 within the first and second portions 56, 58 may emit a common wavelength of light (e.g., light within the blue emission spectrum). The luminescent structure 10, disposed on the first portion 56 of light sources 54, may luminesce in response to receiving emitted excitation light 24 from the first portion 56 of light sources 54 in a second wavelength of light while the second portion 58 of light sources 54 may continue to emit the first wavelength of light. Accordingly, the lighting assembly 46 may contain light sources 54 that emit a common wavelength of light therefrom but produce two or more various colors of light to be emitted therefrom. In various embodiments, individual light sources 54 (e.g., LEDs) may be disposed (e.g., printed, laminated, captured) on substrate 52. In FIG. 3, discrete units appear to be illustrated as light sources 54, however, it is contemplated that the light sources 54 may include tens, hundreds, and/or thousands of light sources 54. Accordingly, it will be understood that the lighting assembly 46 may incorporate a single continuous light source 54 and/or a plurality of individual light sources 54. In examples where there are a plurality of light sources 54, some or all of the light sources 54 may be independently electrically connected (e.g., through a conductive ink), as would be understood in the art. In independently electrically connected examples of the light sources 54, each of the light sources 54 may be independently addressable, which may allow a controller 122 (FIG. 10) of vehicle control system 120 to create static and dynamic patterns of light by independently illuminating certain light sources 54 and not others.

In some embodiments, an overmold material (not shown) may cover, and/or contact, the substrate 52 and the light sources 54. In some embodiments, the overmold may protect the light sources 54 and/or the substrate 52 from physical and chemical damage arising from environmental exposure. The overmold material may also provide aesthetic properties and or properties configured to inhibit (such as ultraviolet light) or otherwise change properties of either the converted light 26 or excitation light 24.

FIG. 4 depicts an interior portion 60 of motor vehicle 30, generally illustrated as having a passenger compartment and a vehicle door (front door 34) that may be in the closed position as shown in FIG. 1 or may pivot about hinge assemblies (not shown) to an open position to allow access to the passenger compartment. The front door 34 includes a handle 80 with a grip portion that allows an operator's hand to grip the handle 80 to transition the front door 34 between open and closed positions. The front door 34 may also include a latch/unlatch assembly 82 for latching the door 34 in the closed position to maintain the door closed and for unlatching the door to allow the door to open to an open position. The latch assembly 82 may include an actuatable latch such as an electromagnetic actuated latch 70 that is coupled to vehicle control system 120 and that changes the position of the latch between latched and unlatched positions in response to a control signal from vehicle control system 120. While a front driver side portion is shown and described in the interior portion 60 of FIG. 4, it should be appreciated that each door in motor vehicle 30 may be equipped with a handle 80 and latch assembly 82 as described in more detail below.

Motor vehicle 30 may also incorporate one or more audio speakers 74 within interior portion 60 to provide a chime or other audible warning. Audio speakers 74 may also be coupled with vehicle control system 120 and activated based on a control signal, as described in more detail below.

In at least one embodiment, latch assembly 82 may include provisions allowing vehicle control system 120 to know when an operator's hand is moving toward handle 80, and thereafter make various control decisions. In some embodiments, latch assembly 82 may include a plurality of proximity sensors 84 on the grip portion of the handle 80 to allow an operator to actuate the latch 70 to the unlatched position to release the door and allow the door to open. In particular, in at least one case, handle 80 may include one or more sets of proximity sensors 88 on handle 80 for sensing an object, such as an operator's hand gripping the handle 80.

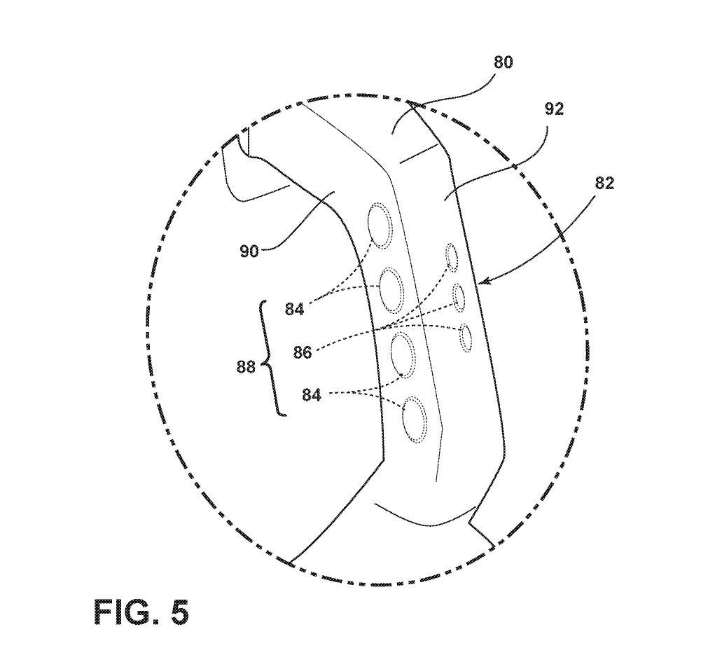

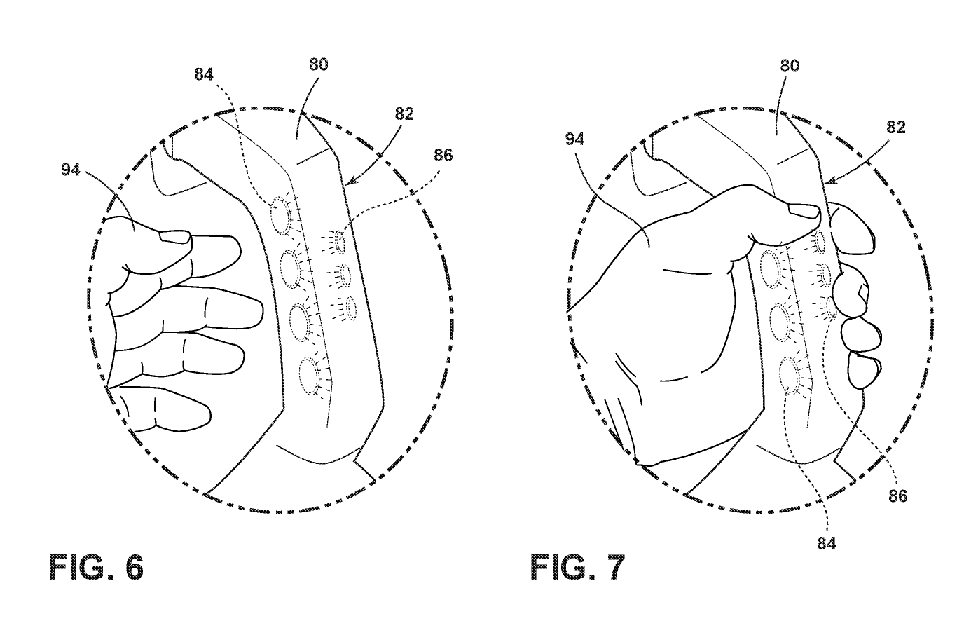

Referring to FIGS. 5-7 of the illustrated embodiment, handle 80 may include a plurality of proximity sensors 88, also labeled and referred to as first set of proximity sensors 84 and second set of proximity sensors 86 arranged on a first side 90 and second side 92, respectively, of the grip portion of handle 80. In at least one embodiment, the first set of proximity sensors 84 may extend vertically on first side 90 of handle 80 and the second set of proximity sensors 86 may extend vertically on the second side 92 of handle 80. In such a case, the first and second sets of proximity sensors 84 and 86 may be positioned so as to be engaged by an operator's hand 94 as seen in FIGS. 6 and 7. In FIG. 6, as an operator's hand 94 reaches for or moves into close proximity to handle 80, one or more of the first and second sets of proximity sensors 84 and 86 may detect the presence of the operator's hand 94, indicating that the operator may be about to grip the handle 80, so as to initiate a latch open activation command, or to prohibit a latch open command based on information from other systems, such as collision detection assembly 51, described in more detail below. In FIG. 7, as an operator's hand 94 grips the handle 80, the thumb and palm of the operator's hand 94 comes into contact or close proximity to the first set of proximity sensors 84 and the fingers wrap around the handle 80 such that the fingers at an end closer to the proximal tip thereof come into contact or close proximity to the second set of proximity sensors 86. The first and second set of proximity sensors 84 and 86 thereby detect the simultaneous presence of an operator's hand 94 on both first and second sides of the handle 80, which is indicative of an operator gripping the handle 80, so as to initiate a latch open activation command, or to otherwise prohibit a latch open command based on information from other systems, such as collision detection assembly 51, described in more detail below.

It should be appreciated that the first and second set of proximity sensors 84, 86, shown as a total of four and three sensors, respectively, are only illustrative and it should be appreciated that any number of sensors may be employed in the plurality of proximity sensors 88. Additionally, it should be appreciated that the proximity sensors may be provided on different sides of the handle 80, or in other areas of the interior portion 60 of motor vehicle 30. The plurality of proximity sensors 88 referenced herein may also be embodied according to types of sensors and techniques that would be known and adapted by a skilled artisan. For example, each of the plurality of proximity sensors 88 may include, but are not limited to, capacitive sensors, inductive sensors, optical sensors, temperatures sensors, resistive sensors, the like, a hybrid of any of these technologies or any other similar technology as would be known or contemplated in the art.

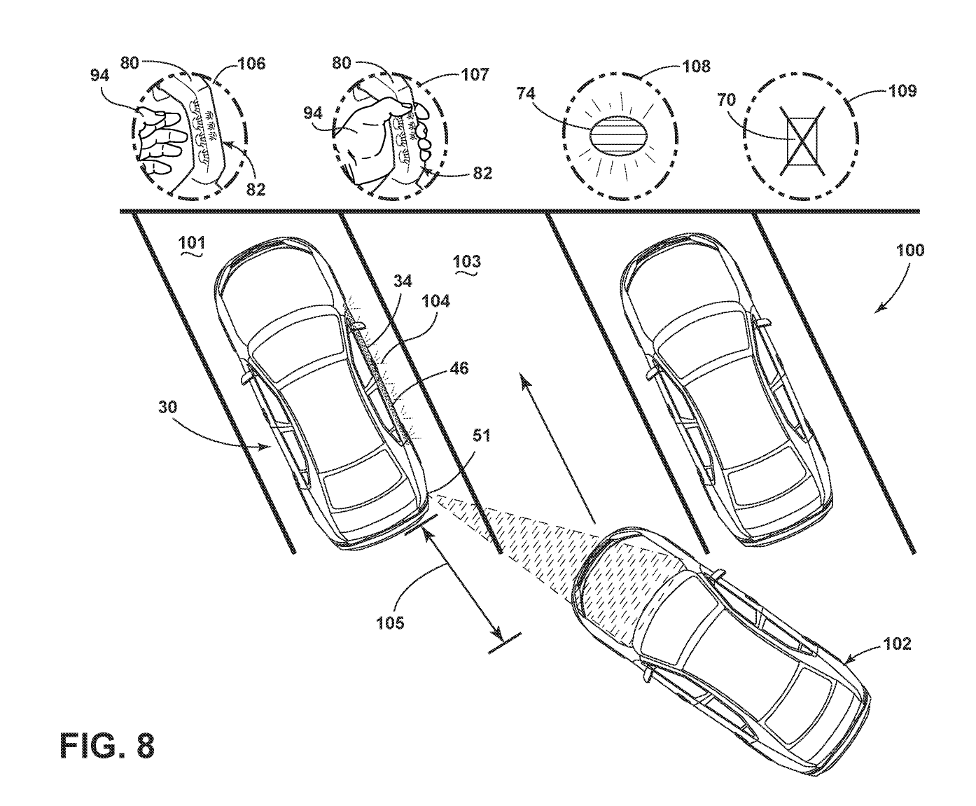

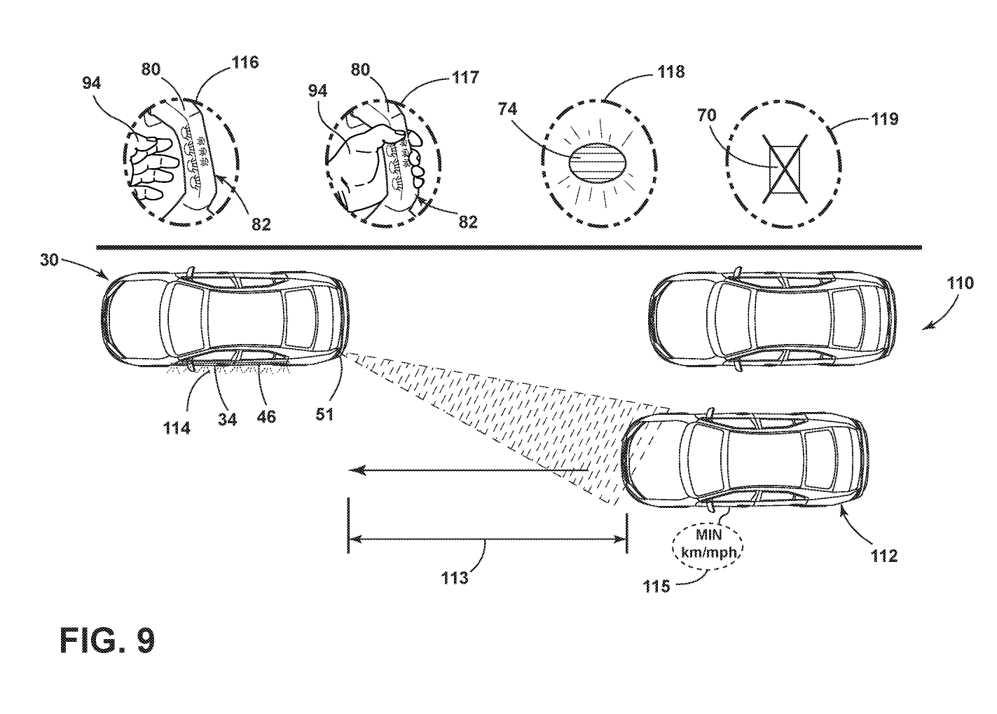

According to aspects described herein, motor vehicle 30 may be configured to process inputs from various systems within the motor vehicle and to actuate one or more warning signals to avoid a potential collision. For example, in some embodiments, vehicle control system 120 of motor vehicle 30 may be configured to receive inputs from the plurality of proximity sensors 88 as well as the collision detection assembly 51, and to actuate various warning signals and mechanisms for motor vehicle 30 to help avoid potential collisions. FIGS. 8 and 9 depict example scenarios 100 and 110 in which methods described herein may be used to warn both an operator of motor vehicle 30 as well as vehicles or other moving obstacles that are approaching motor vehicle 30, and to help motor vehicle 30 avoid a potential collision.

FIG. 8 depicts a scenario 100 in which motor vehicle 30 is in a parked position, i.e., in parking spot 101, and a second motor vehicle 102 is pulling alongside motor vehicle 30 into a parking spot 103, parallel to parking spot 101. In scenario 100, within the interior of motor vehicle 30 proximity sensors 88 have either made the determination that an operator's hand 94 is reaching for the handle 80 (and latch assembly 82) to open a car door (inset 106), or that an operator's hand 94 has grabbed latch assembly 82 to open a car door (inset 107). Additionally, at approximately the same time, collision detection assembly 51 has made a determination that motor vehicle 102 is moving toward motor vehicle 30 and is either within a threshold distance 105 from motor vehicle 30 or is traveling at a threshold speed for a given distance away to make it a potential collision threat if a door of motor vehicle 30 is opened. Upon making the determination, motor vehicle 30 may actuate a warning chime (inset 108) with audio speakers 74, prohibit the unlatch of latch 70 (inset 109), and actuate a warning light 104 that is visible to motor vehicle 102 via one or more light assemblies, e.g. lighting assembly 46, or one or more portions thereof.

FIG. 9 depicts another scenario 110 in which motor vehicle 30 is in a parked position, and a second motor vehicle 112 traveling in a direction parallel to motor vehicle 30 such that motor vehicle 112 will pass alongside motor vehicle 30. In scenario 110, within the interior of motor vehicle 30, proximity sensors 88 have either made the determination that an operator's hand 94 is reaching for the handle 80 (latch assembly 82) to open a car door (inset 116), or that an operator's hand 94 has grabbed handle 80 (latch assembly 82) to open a car door (inset 117). Additionally, at approximately the same time, collision detection assembly 51 has made a determination that motor vehicle 112 is moving toward motor vehicle 30 and is either within a threshold distance 113 from motor vehicle 30 or is traveling at a minimum threshold speed (inset 115) for being a given distance away to make it a potential collision threat if a front door 34 of motor vehicle 30 is opened. Upon making the determination, motor vehicle 30 may actuate a warning chime (inset 118) with audio speakers 74, prohibit the unlatch of latch 70 (inset 119), and actuate a warning light 114 that is visible to motor vehicle 112 via one or more light assemblies, e.g. lighting assembly 46.

It should be understood that the scenarios depicted in FIGS. 8 and 9 are only exemplary of many scenarios and embodiments that are contemplated by the methods described herein. For example, FIGS. 8 and 9 both depict scenarios where the motor vehicle is approaching motor vehicle 30 from the rear, however, the moving obstacle could also be detected as approaching from a front of motor vehicle 30. Those skilled in the art will recognize the many different embodiments encompassed by the present disclosure.

In at least some embodiments, referring to FIG. 10, motor vehicle 30 may include vehicle control system 120, which is coupled to and configured to communicate with the various components and systems of motor vehicle 30. Further, FIG. 10 depicts a controller 122 as part of vehicle control system 120 according to at least one embodiment described herein. Controller 122 may be configured to receive inputs from components of motor vehicle 30, such as various sensors and systems, and also to control a variety of components in motor vehicle 30, such as lights, electro-mechanical devices and systems and other automatically controlled devices. For example, controller 122 may be configured to generate various outputs and signals to actuate warning systems of motor vehicle 30. Controller 122 may be configured as would be understood in the art, and at the very least includes a processor 124 and memory 126. Processor 124 may be configured to run various control algorithms and routines present in memory 126, such as routine 140 and routine 150. It will be understood and appreciated that vehicle control system 120 and controller 122 may include various other analog or digital circuitries that would be known in the art, and the depiction in FIG. 10 is for illustrative purposes only, and is simplified for understanding of the concepts pertinent to aspects described herein.

Controller 122 may be coupled to a variety of sensors and systems within motor vehicle 30 to detect when an operator is about to open a door via an interior door handle 80, as well as to determine if a moving obstacle outside of motor vehicle 30 is approaching. In at least one embodiment, motor vehicle 30 includes one or more proximity sensors 88 for detecting an operator's hand moving to a handle 80, as described above. Motor vehicle 30 may also include collision detection assembly 51 for detecting a moving obstacle outside of motor vehicle 30, as well as various parameters associated with the moving obstacle such as distance from motor vehicle 30, traveling speed, and direction of travel. FIG. 10 is a simplified depiction of a controller 122 associated with motor vehicle 30, and it will also be appreciated that motor vehicle 30 may include a variety of other known sensors and mechanisms for gathering information for controller 122, or for controlling aspects of motor vehicle 30, including the systems and processes described herein as well as those not discussed herein

Controller 122 may be configured to request and/or receive inputs from the various sensors and systems to make decisions and control aspects or various components of motor vehicle 30. In one aspect, controller 122 may receive an indication that an operator's hand is moving toward an interior door handle 80 from proximity sensor 88, and may receive various parameters associated with an obstacle moving toward motor vehicle 30 from collision detection assembly 51. Such inputs may inform various control routines, such as routine 140 and routine 150, as described in more detail below. The various inputs may also facilitate control of components, such as the actuation of lighting assembly 46, the actuation of audio speakers 74, and the control of latch 70.

According to embodiments described herein, memory 126 may store various processing routines that controller 122 may use to actuate warning signals in motor vehicle 30 to help avoid potential collisions. For example, according to one embodiment, controller 122 may initiate routines 140 and 150 to control warning signals such as lighting assembly 46, audio speakers 74 for an audible chime warning, and to control latch 70 to prevent the unlatching of a door. Specifically, if a moving obstacle is detected as being a potential collision threat to the opening of a door, controller 122 may actuate one or more of lighting assembly 46, an audible chime warning within the interior of motor vehicle 30 via audio speakers 74, and control the latch 70.

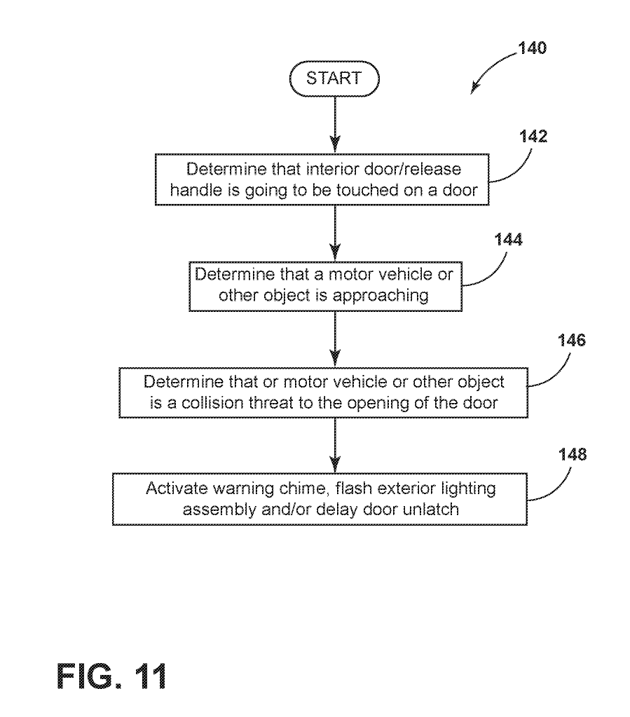

Referring to FIG. 11, routine 140 may be implemented by controller 122 according to an embodiment described herein. Specifically, at step 142, controller 122 first receives input from any of the plurality of proximity sensors 88 to determine that an operator's hand is in close proximity to interior door handle 80 or that handle 80 has been grabbed by the operator's hand, indicating a car door is about to be opened. At step 144, controller 122 receives input from a collision detection assembly 51 and determines that another motor vehicle or other moving obstacle is approaching motor vehicle 30. The input at step 144 may include parameters such as a distance of the moving obstacle from motor vehicle 30 or other position data, a speed of the moving obstacle, a direction of travel, or other contemplated parameters. At step 146, based on a review of the parameters received, controller 122 determines that the motor vehicle or other moving obstacle is a collision threat to motor vehicle 30.

Step 146 may include assessing the various parameters associated with the potential collision threat to motor vehicle 30. In some embodiments, controller 122 may determine whether the motor vehicle or moving obstacle is within a threshold distance away from motor vehicle 30 such that it will always be a collision threat to motor vehicle 30. For example, according to some embodiments, controller 122 may determine that the motor vehicle or moving obstacle is a collision threat if it is ten feet away from motor vehicle 30 and moving toward motor vehicle (as opposed to away from motor vehicle) and thereafter move to step 148. In other cases, controller 122 may see a collision threat based on the motor vehicle or moving obstacle being only five feet away from motor vehicle 30. In still other cases, the threshold distance may be set based on other considerations that would be contemplated by a skilled artisan.

In other cases, even if the motor vehicle or moving obstacle is not within a threshold distance away from motor vehicle 30, controller 122 may determine whether the motor vehicle or other moving obstacle is traveling above a threshold speed for a given distance away from motor vehicle 30 such that the other motor vehicle or moving obstacle may still be a collision threat within a threshold time period. For example, a bicycle traveling at 15 mph that is 500 feet away from motor vehicle 30 may not be a collision threat to motor vehicle 30, but a bicycle traveling at 15 mph that is only 30 feet away may be a collision threat within a few seconds. Thus, according to aspects described herein, in at least some embodiments, the method may include a threshold time period for being a collision threat to motor vehicle 30.

The threshold time period (i.e., the time it would take for a motor vehicle or other moving obstacle to reach motor vehicle 30 based on its distance away from motor vehicle 30 and its traveling speed) for reaching motor vehicle 30 may be set by one of skill in the art. In some cases, the threshold time period may be set as a few seconds (or the time it takes for a door to open). In at least one case, the threshold time period may be set at four seconds. In other words, if controller 122 determines, based on information from collision detection assembly, that a motor vehicle or other moving obstacle will be a collision threat in four seconds or less, controller 122 may proceed to step 148 to actuate one or more warning signals. In still other cases, the threshold time period may be set based on other considerations that would be contemplated by a skilled artisan.

Finally, at step 148, if it is determined that a motor vehicle or other moving obstacle is a collision threat, controller 122 may cause actuation of one or more warning signals in motor vehicle 30. More specifically, motor vehicle 30 may emit a warning sound via audio speakers 74, actuate lighting assembly 46, or other warning lights, and/or prohibit the unlatch of latch 70.

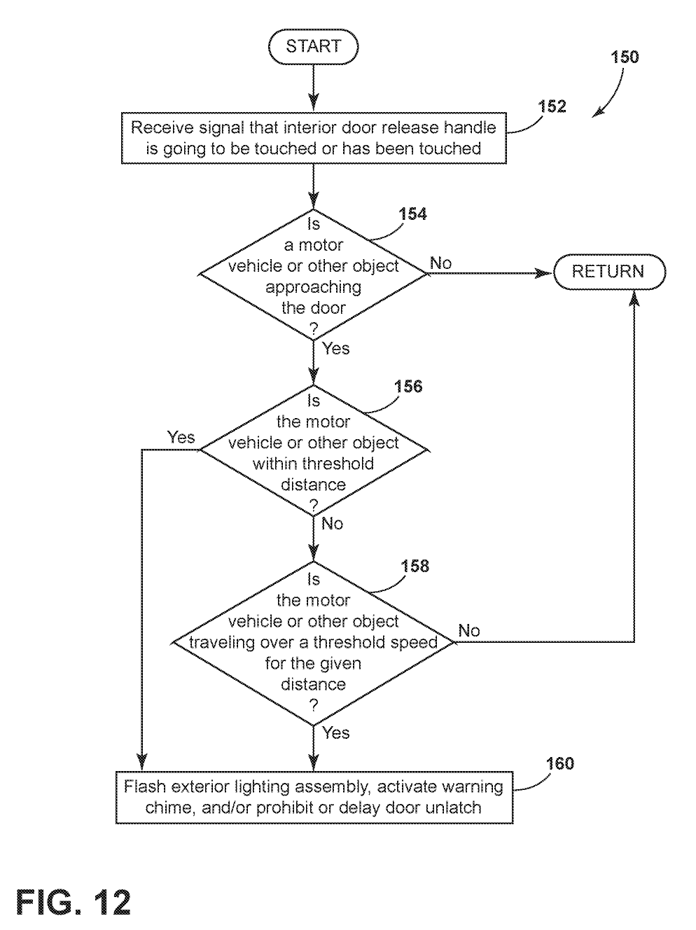

Accordingly, FIG. 12 depicts a collision avoidance routine 150 that may be implemented by controller 122 according to an embodiment described herein. At step 152, controller 122 may first receive a signal that an interior handle 80 is going to be touched or has been touched. In at least one embodiment, as described above, controller 122 may receive information from one or more proximity sensors 88 located on handle 80. Once the signal of step 152 has been received, at step 154, controller 122 determines whether a motor vehicle or other moving object is approaching motor vehicle 30. The determination at step 154 may be based on information received from other sensors, such as collision detection assembly 51. If it is determined at step 154 that there is no motor vehicle or other obstacle approaching motor vehicle 30, the routine returns to a start position. However, if it is determined at step 154 that there is a motor vehicle or other obstacle approaching motor vehicle 30, the routine moves to step 156. At step 156, controller 122 may determine if the motor vehicle or other moving obstacle (determined at step 154) is within a threshold distance away from motor vehicle (i.e., is close enough to be a collision threat regardless of traveling speed), and moving toward—not away from—motor vehicle such that warning signals should be activated, the routine moves to step 160 to actuate warning signals. If the motor vehicle or other moving obstacle is not determined to be within a threshold distance from motor vehicle 30 at step 156, the routine moves to step 158 to determine if the motor vehicle or other moving obstacle may still be traveling over a threshold speed for a given distance from motor vehicle 30 such that it is still a collision threat to motor vehicle 30. If the answer is NO at step 158, the routine returns to a start position. If, however, at step 158 it is determined that the motor vehicle or other moving obstacle is traveling over a threshold speed for the given distance from motor vehicle 30 such that it is still a collision threat, the routine proceeds to step 160 and controller 122 causes one or more systems within motor vehicle 30 to actuate one or more warning signals, as described above.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method for actuating a warning light on a motor vehicle comprising:
detecting an operator's hand in close proximity to an interior handle of a door having at least one proximity sensor on the interior handle;
receiving position data for a moving obstacle relative to the motor vehicle;
determining that the moving obstacle is a collision threat to the opening of the door based on the position data; and
actuating the warning light.

2. The method of claim 1, wherein the warning light comprises a light assembly on an exterior surface of the door.

3. The method of claim 1, wherein the warning light comprises a luminescent structure.

4. The method of claim 1, wherein the warning light comprises a plurality of LEDs.

5. The method of claim 1, further comprising:
detecting the moving obstacle with a collision detection system coupled to the motor vehicle.

6. The method of claim 1, further comprising:
determining a traveling speed of the moving obstacle.

7. The method of claim 6, wherein determining that the moving obstacle is a collision threat to the opening of the door includes determining that the traveling speed is over a threshold speed for the position data.

8. The method of claim 1, further comprising:
actuating a warning sound within the motor vehicle.

9. The method of claim 1, further comprising:
delaying a door latch to unlatch the door.

10. The method of claim 1, further comprising:
detecting, by the at least one proximity sensor, the operator's hand in close proximity to the interior handle of the door and not gripping the interior handle of the door for a threshold time period; and
deactivating the warning light after the threshold time period.

11. A method comprising:
detecting an operator's hand close to at least one proximity sensor on an interior handle of a door in a motor vehicle;
detecting a moving obstacle outside of the motor vehicle by a collision detection system coupled to the motor vehicle;
determining that the moving obstacle is a collision threat to the opening of the door; and
actuating a warning signal.

12. The method of claim 11, further comprising:
determining that the moving obstacle is a collision threat to the opening of the door based on a the moving obstacle's distance from the motor vehicle.

13. The method of claim 12, further comprising:
determining that the moving obstacle is a collision threat to the opening of the door based on a calculation of the moving obstacle reaching the motor vehicle in under a threshold time period based on a traveling speed of the moving obstacle and the moving obstacle's distance from the motor vehicle.

14. The method of claim 11, wherein the warning comprises a warning light on an exterior surface of the motor vehicle.

15. The method of claim 14, wherein the warning light comprises a light assembly on an exterior surface of the door.

16. The method of claim 14, wherein the warning light comprises a luminescent structure.

17. The method of claim 14, wherein the warning light comprises a plurality of LEDs.

18. The method of claim 11, wherein the warning signal is a warning sound within the motor vehicle.

19. The method of claim 11, further comprising:
delaying a door latch to unlatch the door.

20. A system for collision avoidance in a motor vehicle, the system comprising:
at least one proximity sensor on an interior door handle for detecting an operator's hand in close proximity to the interior door handle;
a collision detection system for detecting a moving obstacle outside of the motor vehicle and the moving obstacle's distance from the motor vehicle;
a warning light on an exterior surface of the motor vehicle;
control circuitry coupled to the at least one proximity sensor, the collision detection system and the warning light, the control circuitry configured to actuate the warning light based on detection of the operator's hand in close proximity to the interior door handle and the moving obstacle being within a threshold distance from the motor vehicle.
